(19) United States
(12) Patent Application Publication
(10) Pub. No.: US 2005/0123181 A1
(43) Pub. Date: Jun. 9, 2005

(54) Automated microscope slide tissue sample mapping and image acquisition

(76) Inventors: Philip Freund, Seattle, WA (US); Walter Harris, Bremerton, WA (US); Christopher Ciarcia, Los Alamos, NM (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/961,902

(22) Filed: Oct. 8, 2004

Related U.S. Application Data
(60) Provisional application No. 60/509,671, filed on Oct. 8, 2003.

(51) Int. Cl. G06K 9/00

(52) U.S. Cl. 382/128

(57) ABSTRACT

A method comprises receiving an image of a tissue-sample set. A position in the image of each tissue sample relative to at least one other tissue sample is electronically identified. Each tissue sample is electronically identified based on the tissue sample position identification.

### CROSS REFERENCE TO RELATED APPLICATION

The present application claims priority from U.S. Provisional Application No. 60/509,671 filed Oct. 8, 2003 and which is incorporated herein by reference in its entirety for all purposes.

### BACKGROUND

Medical research and treatment require rapid and accurate identification of tissue types, tissue structures, tissue substructures, and cell types. The identification is used to understand the human genome, interaction between drugs and tissue, and treat disease. Pathologists historically have examined individual tissue samples through microscopes to locate structures of interest within each tissue sample, and made identification decisions based in part upon features of the located structures of interest. However, pathologists are not able to handle the present volume of tissue samples requiring identification. Furthermore, because pathologists are human, the current process relying on time-consuming visual tissue analysis is inherently slow, expensive, and suffers from normal human variations and inconsistencies.

Adding to the volume of tissue samples requiring identification is a recent innovation using tissue microarrays for high-throughput screening and analysis of hundreds of tissue specimens on a single microscope slide. Tissue microarrays provide benefits over traditional methods that involve processing and staining hundreds of microscope slides because a large number of specimens can be accommodated on one master microscope slide. This approach markedly reduces time, expense, and experimental error. To realize the full potential of tissue microarrays in high-throughput screening and analysis, a fully automated system is needed that can match or even surpass the performance of a pathologist working at the microscope. Existing systems for tissue identification require high-magnification or high-resolution images of the entire tissue sample before they can provide meaningful output. The requirement for a high-resolution image slows capture of the image, requires significant memory and storage, and slows the identification process. An advantageous element for a fully automated system is a device and method for capturing high-resolution images of each tissue sample limited to structures-of-interest portions of the tissue sample. Another advantageous element for a fully automated system is an ability to work without requiring the use of special stains or specific antibody markers, which limit versatility and speed of the throughput.

In view of the foregoing, there is a need for a new and improved device and method for automated identification of structures of interest within tissue samples and for capturing high-resolution images that are substantially limited to those structures. The present invention is directed to a device, system, and method.

### SUMMARY OF THE INVENTION

According to an embodiment of the invention, a method comprises receiving an image of a tissue-sample set. A position in the image of each tissue sample relative to at least one other tissue sample is electronically identified. Each tissue sample is electronically identified based on the tissue sample position identification.

### BRIEF DESCRIPTION OF THE DRAWINGS

The invention, together with further objects and advantages thereof, may best be understood by making reference to the following discussion taken in conjunction with the accompanying drawings, in the several figures of which like referenced numerals identify like elements, and wherein:

FIG. 1A illustrates a robotic pathology microscope having a lens focused on a tissue-sample of a tissue microarray mounted on a microscope slide, according to an embodiment of the invention;

FIG. 1B illustrates an auxiliary digital image of a tissue microarray that includes an array level digital image of each tissue sample in the tissue microarray, according to an embodiment of the invention;

FIG. 1C illustrates a digital tissue sample image of the tissue sample acquired by the robotic microscope at a first resolution, according to an embodiment of the invention;

FIG. 1D illustrates a computerized image capture system providing the digital tissue image to a computing device in a form of a first pixel data set at a first resolution, according to an embodiment of the invention;

FIG. 2 is a block diagram of an electronic system according to an embodiment of the invention;

FIG. 3 is a schematic view of a microscope slide upon which is mounted a tissue sample array;

FIG. 4 is a diagram illustrating a stretch function employed during a tissue mapping process according to an embodiment of the invention;

FIG. 5 is a schematic and functional view of a histogram analysis of a tissue-sample image according to an embodiment of the invention;

FIG. 6 is a schematic and functional view of the superimposition of a generated theoretical array superimposed upon the tissue array of FIG. 3 according to an embodiment of the invention;

FIG. 7 is a flowchart illustrating a method according to an embodiment of the invention;

FIG. 8 is a class diagram illustrating several object class families in an image capture application that automatically captures an image of a structure of interest in a tissue sample, according to an embodiment of the invention; and

FIG. 9 is a diagram illustrating a logical flow of a computerized method of automatically capturing an image of a structure of interest in a tissue sample, according to an embodiment of the invention.

### DETAILED DESCRIPTION

In the following detailed discussion of exemplary embodiments of the invention, reference is made to the accompanying drawings, which form a part hereof. The detailed discussion and the drawings illustrate specific exemplary embodiments by which the invention may be practiced. Other embodiments may be utilized, and other changes may be made, without departing from the spirit or scope of the present invention. The following detailed discussion is therefore not to be taken in a limiting sense, and the scope of the present invention is defined by the claims. A reference to the singular includes a reference to the plural unless otherwise stated or inconsistent with the disclosure herein.

Some portions of the discussions that follow are presented in terms of algorithms and symbolic representations of operations on data bits within a computing device. An algorithm is here, and generally is conceived to, be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, throughout the present discussion terms such as “processing” or “computing” or “calculating” or “determining” or “displaying” or “electronically” or the like, refer to actions and processes of an electronic computing device, such as a computer system or similar device, that manipulates and transforms data represented as physical (electronic) quantities within the computer system's registers and memories into other data similarly represented as physical quantities within the computer system memories or registers or other such information storage, transmission, or display devices.

Additional description is contained in “Automated LifeSpan Imaging and Analysis System (ALIAS),” bearing a print-out date of Sep. 19, 2003, and in “Microscope Slide Tissue Mapping,” bearing a print-out date of Oct. 7, 2003, both of which are attached hereto and incorporated herein by reference in their entirety for all purposes.

The process used by histologists and pathologists includes visually examining tissue samples containing cells having a fixed relationship to each other and identifying patterns that occur within the tissue. Different tissue types have different structures and substructures of interest to an examiner (hereafter collectively “structures of interest”), a structure of interest typically having a distinctive pattern involving constituents within a cell (intracellular), cells of a single type, or involving constituents of multiple cells, groups of cells, and/or multiple cell types (intercellular).

The distinctive cellular patterns are used to identify tissue types, tissue structures, tissue substructures, and cell types within a tissue. Recognition of these characteristics need not require the identification of individual nuclei, cells, or cell types within the sample, although identification can be aided by use of such methods. Individual cell types within a tissue sample can be identified from their relationships with each other across many cells, from their relationships with cells of other types, from the appearance of their nuclei, or other intracellular components.

Tissues contain specific cell types that exhibit characteristic morphological features, functions, and/or arrangements with other cells by virtue of their genetic programming. Normal tissues contain particular cell types in particular numbers or ratios, with a predictable spatial relationship relative to one another. These features tend to be within a fairly narrow range within the same normal tissues between different individuals. In addition to the cell types that provide a particular organ or tissue with the ability to serve its unique functions (for example, the epithelial or parenchymal cells), normal tissues also have cells that perform functions that are common across organs, such as blood vessels that contain hematologic cells, nerves that contain neurons and Schwann cells, structural cells such as fibroblasts (stromal cells) outside the central nervous system, some inflammatory cells, and cells that provide the ability for motion or contraction of an organ (e.g., smooth muscle). These cells also form patterns that tend to be reproduced within a fairly narrow range between different individuals for a particular organ or tissue, etc.

Histologists and pathologists typically examine specific structures of interest within each tissue type because that structure is most likely to contain any abnormal states within a tissue sample. A structure of interest typically includes the cell types that provide a particular organ or tissue with its unique function. A structure of interest can also include portions of a tissue that are most likely to be targets for treatment of drugs, and portions that will be examined for patterns of gene expression. Different tissue types generally have different structures of interest. However, a structure of interest may be any structure or substructure of tissue that is of interest to an examiner.

As used in this document, reference to “cells in a fixed relationship” generally means cells that are normally in a fixed relationship in the organism, such as a tissue mass. Cells that are aggregated in response to a stimulus are not considered to be in a fixed relationship, such as clotted blood or smeared tissue.

A typical microscope slide has a tissue surface area of about 1875 mm². The approximate number of digital images required to cover that area, using a 20× objective, is 12,500, which would require approximately 50 gigabytes of data storage space. Additionally, multi-tissue-arrays (MTA's) are routinely used where a single slide contains multiple tissue specimens and possibly from different organ types and/or from different patients. In order to make analysis of tissue slides conducive to automation and economically feasible, it becomes necessary to reduce the number of images required to make a determination. It is also necessary to locate and differentiate tissues from one another for the application of tissue imaging and analysis processes. In addition, the process must proceed in an unattended fashion such that user intervention is minimized or eliminated.

Automated microscope slide tissue mapping assists in achieving the above requirements. The mapping requires both hardware and software components. The software includes a process applied to determine imaging information that defines the physical characteristics of tissue specimens on a microscope slide, and associates this information with a tissue identity database description of that slide. This process is applicable to a wide variety of microscope slide array configurations including those containing one to many tissue specimens. The tissue mapping process enables targeted imaging of specific tissues on the slide in a high throughput robotic microscope environment.

Aspects of the invention are well suited for capturing selected images from tissue samples of multicellular cells in a fixed relationship structures from any living source, particularly animal tissue. These tissue samples may be acquired from a surgical operation, a biopsy, or similar situations where a mass of tissue is acquired. In addition, aspects of the invention are also suited for capturing selected images from tissue samples of smears, cell smears, and bodily fluids.

A camera image data set is captured which provides the entire Field of View (FOV) of the area of the slide where tissues may be populated. Next, the Tissues are segmented from the background and artifacts such as dust, air bubbles, labels, and other anomalies commonly found on microscope slides. Using database knowledge of the number of expected tissues and the tissue block format (blocks, rows, columns, etc.) the process then fits the arrangement of the found tissues to the layout assigned to the slide. The software makes corrections for tissue warpage, tearing, and fragmentation as part of the fitting exercise. The software also associates tissues that fall outside of the expected array with the correct position in the array. The tissue mapping process results in the determination and recording of slide image tissue information including tissue location, radius, boundaries, optical density, and population maps for each tissue.

A system for automated microscope slide tissue sample mapping according to an embodiment of the invention includes the following iterative steps:
Whole-slide imaging: Using a robotic microscope and a digital camera to capture an image of the entire slide surface at a low magnification.
Tissue Section Mapping: From the image of the slide surface, identifying blobs as being tissue, distinct from artifacts that may be present; recording the position of identified tissues; and correlating their position on the slide to tissue identities that are recorded in a database.
Low magnification tissue image acquisition: Acquisition of tiled images about each mapped tissue section. Individual image tiles cover overlapped fields of view in order to facilitate image stitching.
Low Magnification Region of Interest (ROI) Targeting: Analysis of a stitched, composite image of the image tiles to locate prescribed tissue structures and cell types that are of interest in a tissue. Where specific cell types of interest are not detectable at the low magnification, regions where the desired cell types are known to exist are located, and the coordinates recorded.
Targeted ROI image acquisition: Using coordinates recorded from Low Magnification Targeting, the robotic microscope is directed to acquire images of specific structures and cell types of interest, at higher, prescribed magnifications.
High Magnification ROI Targeting: Higher magnification images are analyzed for structure and cell-type content; the coordinates of the structures are recorded and the tissue goes through another iteration of imaging at a higher, prescribed magnification; or the image is further analyzed for the localization and intensity of a marker probe.

This system has important advantages over whole slide scanning, which generally involves acquiring tiled images for the entire slide surface, and performing image analysis on each image, in a separate, secondary process. The targeted-imaging approach used in this system minimizes the number of images that must be acquired to make analytical determinations. This confers considerable savings in terms of the time required to process analyses, as well as the amount of storage space required to save digital images. Automation of digital image capture and analysis may assist more consistent diagnosis, significant cost savings and/or increased throughput.

Whole Slide Imaging

Using a robotic microscope equipped with a motorized stage, and a digital camera, images of the slide surface are acquired at low magnification. One image centers on the portion of the slide that has a barcode label imprinted on it. The barcode image is analyzed by commercially available barcode software, and the slide identification is decoded. The remaining images comprise the field of view containing all of the tissues contained on a slide. These images are used to map the location of the tissue sections, and to identify the tissue type.

Tissue Mapping

The images of the tissue sections are used as input to the mapping software. The software locates tissue sections in the image and distinguishes them from artifacts such as dust, air bubbles, oil droplets, and other anomalies commonly found on microscope slides. The software then fits the arrangement of the found tissues to the layout assigned to the slide. Layout information about a particular slide is received from a slide database using the barcode data for the slide. This data includes information about the number of rows and columns, and about the expected diameter of each tissue element in the array. The software makes corrections for tissue warpage, tearing, and fragmentation as part of the fitting process. Upon fitting each tissue to a given layout position, the tissue type is determined from information taken from the slide database, and a prescribed imaging protocol for that tissue type is followed. The mapping software records pixel coordinates for the boundaries of the tissue. In the case where the section is fragmented, the boundary is calculated from the region that encompasses all found fragments within an expected diameter. The software also has a provision for a user to manually choose tissue locations for coordinate recording. This allows the system to accommodate large, single tissues such as brain, for which a smaller subset of area may be desired for analysis.

Low Magnification Image Acquisition

Using pixel coordinates generated by the mapping software, stage coordinates for each section are calculated and used to direct the robotic microscope. A stage coordinate system is utilized that permits stage coordinates to be generated from different microscopes such that the XY location of any tissue may be accurately reproduced on any microscope. The control software then instructs the microscope to position the slide such that the first tissue section to be imaged is placed beneath the objective. Using a low magnification objective such as 5×, the system acquires tiled images at a rate of coverage that includes a minimal overlap. Based on data derived from the tissue map image, the system acquires images where there is minimal area of non-tissue void space. This is done to reduce the number of images required to cover a particular tissue, thus saving disk storage space and processing time.

Image capture for each tissue section on the slide proceeds in such a way as to minimize the number of long distance travels by the motorized stage, reducing the amount of time required to tile all of the tissue. All microscope and camera functions; including positioning, auto focus, white balance and exposure, are performed by the control software.

Low Magnification Targeting

A set of low magnification, tiled images for each tissue section is stitched into a single, composite image that becomes representative of an entire tissue section. The stitching software accommodates any N×M format of tiled images up to 100² images. The software also handles sparse occupation of the mosaic (missing images), and automatically computes vertical and horizontal phasing, to accommodate stage offsets. These features permit the handling of irregularly shaped tissue sections, which are typical of large tissue sections and smaller, fragmented tissue cores. Image discontinuities are eliminated through the use of full-boundary morphing and three-dimensional matching at the boundaries of the images.

The stitched image is then analyzed to determine the presence of structures and cell types of interest, according to a list of features specific to the tissue associated with the section. One embodiment of such a list is shown in (Table A). In the case where a particular structure or cell type of interest is not visible at this magnification, a region where these features are known to associate is targeted (e.g., Leydig cells in testis). A list of pixel coordinates is generated by the software, which will be used to direct the microscope to acquire higher magnification images of the desired regions of interest. The presence of structures and cell types of interest is determined using a suite of ROI Selector tools that are comprised of sets of tissue-specific filters. The software identifies ROIs in the composite image, and then generates pixel locations along with figures of merit, which are used for the purpose of sorting. An n number of region locations that have the highest values for figure of merit, as specified by a user-defined parameter, are passed to the robotic microscope for imaging at the next higher magnification.

TABLE A
Available tissue classes

| Class | Structures |
|---|---|
| CBladder | Surface Epithelium, Smooth Muscle, Lamina Propria |
| CBreast | Ducts/Lobules, Stroma |
| CColon | Epithelium, Muscularis Mucosa, Smooth Muscle, |
| | Submucosa |
| CHeart | Tissue (generic) |
| CKidneyCortex | Gloms, DCTs |
| CKidneyMedulla | Ducts |
| CLiver | Portal Triad |
| CLung | Alveoli, Respiratory Epithelium |
| CLymphNode | Mantle Zone of Lymphoid Follicle |
| CNasalMucosa | Epithelium |
| CPlacenta | Tissue (generic) |
| CProstate | Glands, Stroma, Epithelium |
| CSkeletalMuscle | Tissue (generic) |
| CSkin | Epidermis |
| CSmallIntestine | Epithelium, Muscularis Mucosa, Smooth Muscle, |
| | Submucosa |
| CSpleen | White Pulp |
| CStomach | Epithelium, Muscularis Mucosa, Smooth Muscle, |
| | Submucosa |
| Ctestis | Leydig Cells |
| CThymus | Lymphocytes, Hassall's Corpuscles |
| CThyroid | Follicles |
| CTonsil | Mantle Zone of Lymphoid Follicle, Epithelium |
| CUterus | Glands, Stroma, Smooth Muscle |

Targeted Image Acquisition and High Magnification Targeting

The control software of the robotic microscope utilizes the list of region coordinates generated by the ROI Selector software, and the microscope is directed to acquire new images at a higher prescribed magnification such that the field of view for each new image primarily contains the structure or cell type of interest. In similar fashion as the previous section, recognition software analyzes the new images for the presence of desired regions of interest. If the ROIs were visible at the previous magnification, then the higher magnification image may be processed for ROI segmentation and localization of probe marker, and/or publication. In the case where only the associated regions for desired ROIs would be visible at the previous magnification, then the new image is analyzed for the desired ROI with a secondary recognition algorithm, and the process undergoes a second iteration. This iterative process of acquisition and analysis to increasingly higher magnifications (resolution) may continue until the desired structures are located or it is determined that the structure is not present in the particular specimen.

Specific Structure Segmentation and Localization of Probe Markers

Higher magnification images resulting from targeted acquisition are analyzed for the presence of desired ROIs using recognition software. The features of interest are identified and separated from the remaining elements in the image. The segmented features are then analyzed for the concurrent presence of a probe marker to a sought component that would be a protein or RNA expression product. The marker would usually be a stain that is distinct from other stains present in the tissue. The co-existence of the marker with the feature of interest would be indicative of localization of the sought component to the structure or cell type. The probe marker is also quantified in order to measure the relative amount of expression of the component within the structure or cell type.

Working Example

The following describes the hardware and software components employed in a working example of a system for automated microscope slide tissue sample mapping. This description is merely illustrative and is not to be considered limiting. The hardware components included:
Leica DMLA automated microscope with 2.5×, 5×, 10×, 20× and 40×;
Diagnostic Instruments Spot InSight 4 camera for microscope image capture;
Three color LED light source;
300 slide auto loading and motorized stage;
Computer hardware including a 2+GHz PC with at least 512 MB of memory and a large (30+MB) hard drive, display screen, and an MS-Windows operating system (2000, NT or 98). A bank of 16 such computers are all loaded with the software. They communicate with each other over a network, using MSMQ (Microsoft Messaging Queue) and messages written in XML format. The software utilizes all of the processing capacity of the PC, so the machines are dedicated to this one purpose. A version of the software also runs on a single desktop PC, and is capable of processing images in a batch-wise manner.

The system also works well using a DVC 1310 camera with an RGB filter wheel attached to a Zeiss Axioplan II microscope. The software may be sensitive to the component set.

The software components included hardware control software for auto-focus, auto-calibration, motion control, image adjustment, and white balance. The software component also included tissue-mapping software that allows the system to perform targeted imaging. The system does not image the whole slide but only regions that contain tissue. Resolution is 0.335 microns/pixel with a 20× objective. Sub-cellular details, including nuclear features, are readily discernable in an image acquired by the system with a 20× objective. Analysis of these 20× images for appropriate cells and structure allows higher-magnification images to be captured for data analysis only when necessary and therefore increases throughput. Barcode-reading software allows slide and tissue related data to be retrieved and filed to an external database.

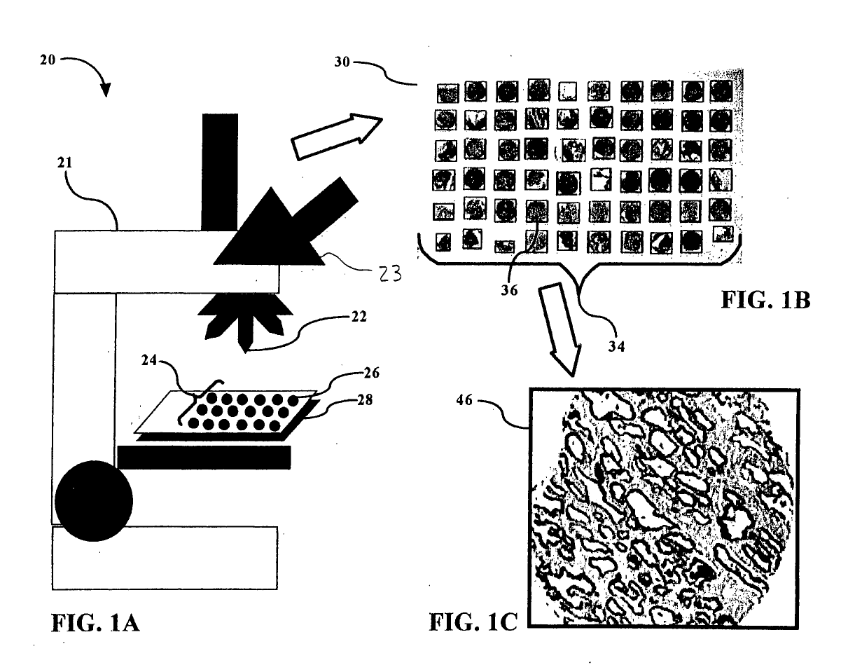

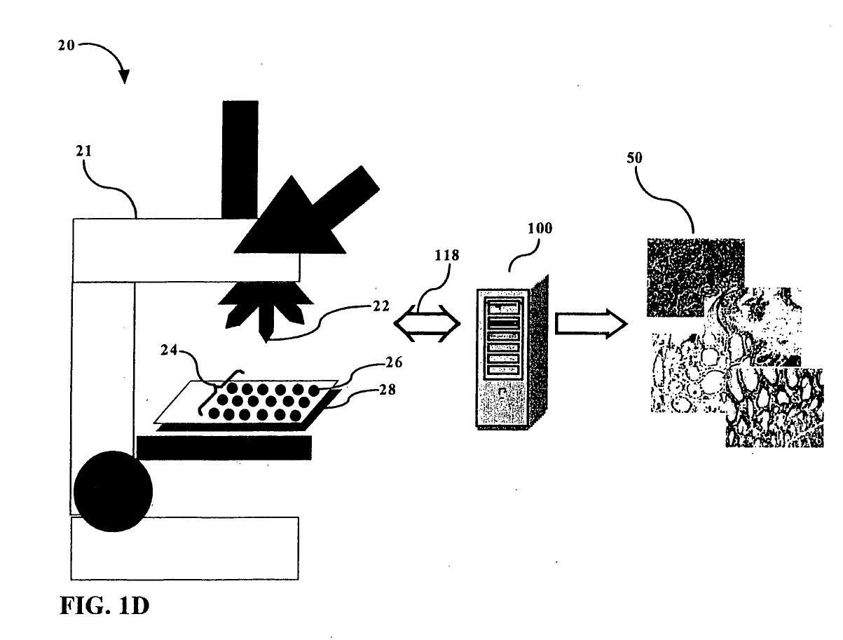

FIGS. 1A-D and 2 illustrate an image capture system 20 capturing a first pixel data set at a first resolution representing an image of a tissue sample of a tissue microarray, and providing the first pixel data set to a computing device 100, according to an embodiment of the invention. FIG. 1A illustrates a robotic pathology microscope 21 having a lens 22 focused on a tissue-sample section 26 of a tissue microarray 24 mounted on a microscope slide 28. The robotic microscope 21 also includes a computer (not shown) that operates the robotic microscope. The microscopic slide 28 has a label attached to it (not shown) for identification of the slide, such as a commercially available barcode or RFID (radio frequency identification) label. The label, which will be referred to herein as a barcode label for convenience, is used to associate a database with the tissue samples on the slide.

Tissue samples, such as the tissue sample 26, can be mounted by any method onto the microscope slide 28. Tissues can be fresh or immersed in fixative to preserve tissue and tissue antigens, and to avoid postmortem deterioration. For example, tissues that have been fresh-frozen, or immersed in fixative and then frozen, can be sectioned on a cryostat or sliding microtome and mounted onto microscope slides. Tissues that have been immersed in fixative can be sectioned on a vibratome and mounted onto microscope slides. Tissues that have been immersed in fixative and embedded in a substance such as paraffin, plastic, epoxy resin, or celloidin can be sectioned with a microtome and mounted onto microscope slides.

The robotic microscope 21 includes a high-resolution translation stage (not shown). The microscope slide 28 containing the tissue microarray 24 may be manually or automatically loaded onto the stage of the robotic microscope 21. As discussed in further detail below, an imaging system 110, that may reside in the computing device 100, acquires a single auxiliary digital image of the full microscope slide 28, and maps the auxiliary digital image to locate the individual tissue sample specimens of the tissue microarray 24 on the microscope slide 28.

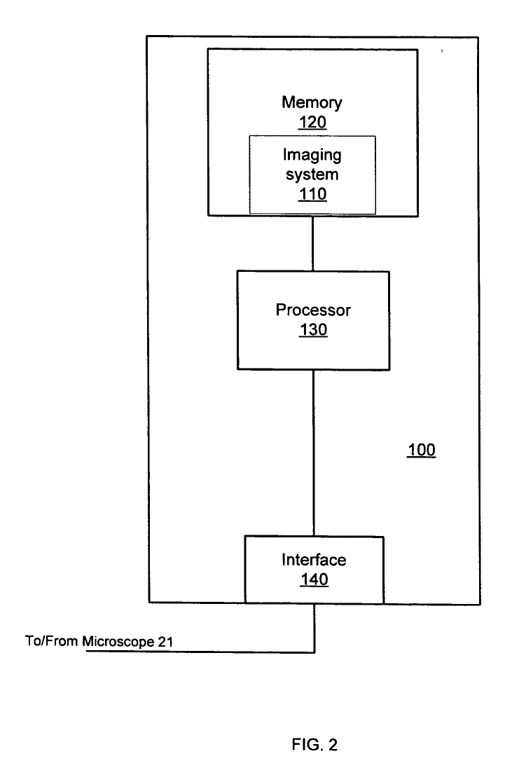

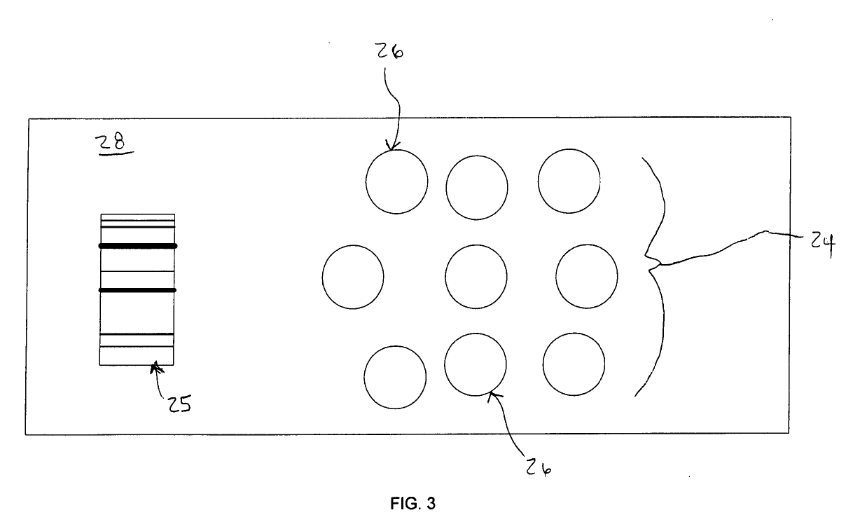

Referring to FIG. 2 and according to an embodiment of the invention, the computing device 100 includes a memory 120, within which resides the software-implemented imaging system 110, a central processing unit (CPU) 130 operable to execute the instructions of which the imaging system is comprised, and an interface 140 for enabling communication between the processor and, for example, the microscope 21.

Referring to FIG. 3, the constituent samples 26 of an exemplary array 24 generally form a 3×3 array. However, as also illustrated and as is typically the case, several of the samples 26 are horizontally and/or vertically misaligned (i.e., the array 24 is “warped”) as a result of inadvertent error in the placement of the tissue samples on the slide 28.

Although the array 24 is warped, a human technician, for example, is able to recognize that the array has a 3×3 configuration. Accordingly, the technician is able to register the identity of each sample 26 in a database for future reference by entering the respective position and identity of each sample within the array 24 into the database (and, by doing so, implicitly also entering the size of the array), along with, for example, a reference numeral associated with the bar code 25 and identifying the slide 28.

Because of warping, however, non-human examination of the array 24 will not intrinsically yield a determination that a particular sample 26 has a particular position within a 3×3 array, and will thus not enable automatic identification of the sample.

As discussed below, the imaging system 110 is operable to map each sample 26 in the tissue array 24 to its corresponding position registered in the above-referenced database, thereby allowing automatic identification of each tissue sample. This mapping function is thus a critical operation in the automated analysis, discussed herein, of tissue samples.

In an embodiment of the invention, a camera image data set is captured by a camera 23 that provides the entire Field of View (FOV) of the area of the slide 28 where a tissue array 24 and bar code 25 may be populated. The image may be a single RGB color image acquired at low (i.e., macroscopic) magnification. The color image is received by the computing device 100, whereupon the image is analyzed and mapped using the imaging system 110 as described in the following discussion.

The FOV image is converted from the RGB color model to HIS (hue, intensity and saturation) format and inverted, placing the imaged tissue samples on the positive scale of the signal domain. All subsequent processing may be derived from the intensity component of the image.

The image is iteratively examined to locate and mask slide fiducials (i.e., boundary or other slide location markers) and/or non-illuminated regions. This may be accomplished, for example, by isolating all pixels less than 18% of the full dynamic range, then examining each connected grouping of these pixels. If a grouping is on the boundary (within 10% of the minimum of the width or height of the image FOV) and its pixel density is less than 0.04 percent of the total number in the image, then the grouping is assumed to be a fiducial or a non-illuminated region and it is tagged and masked as a non-process region for all subsequent steps.

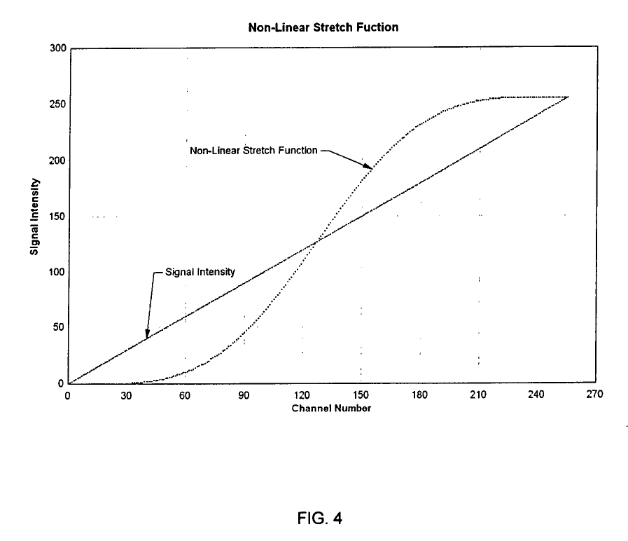

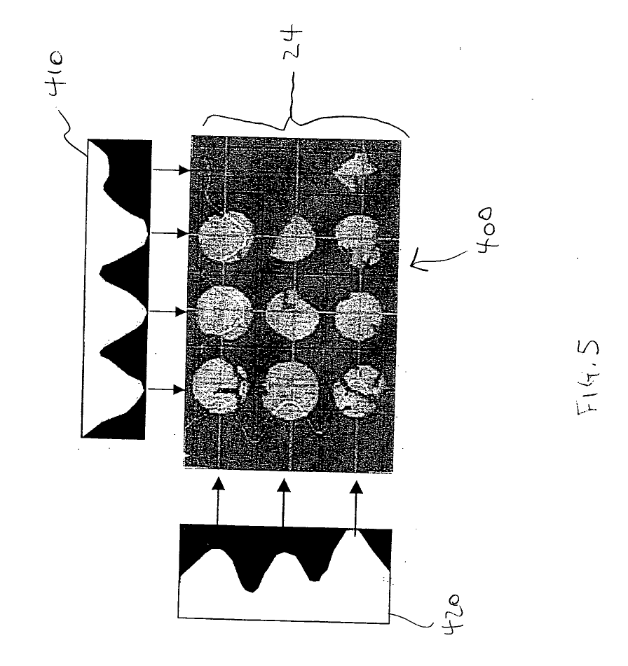

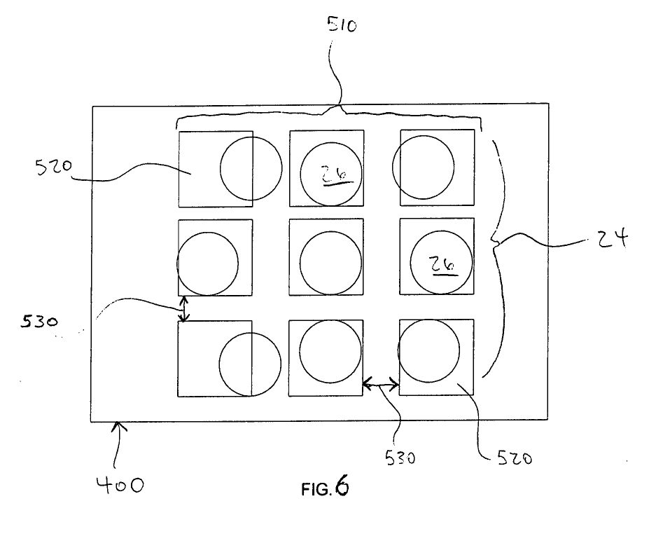

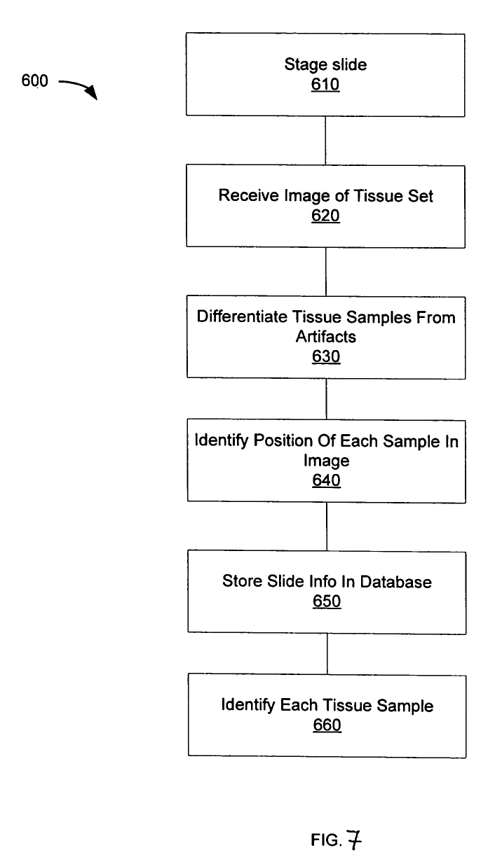

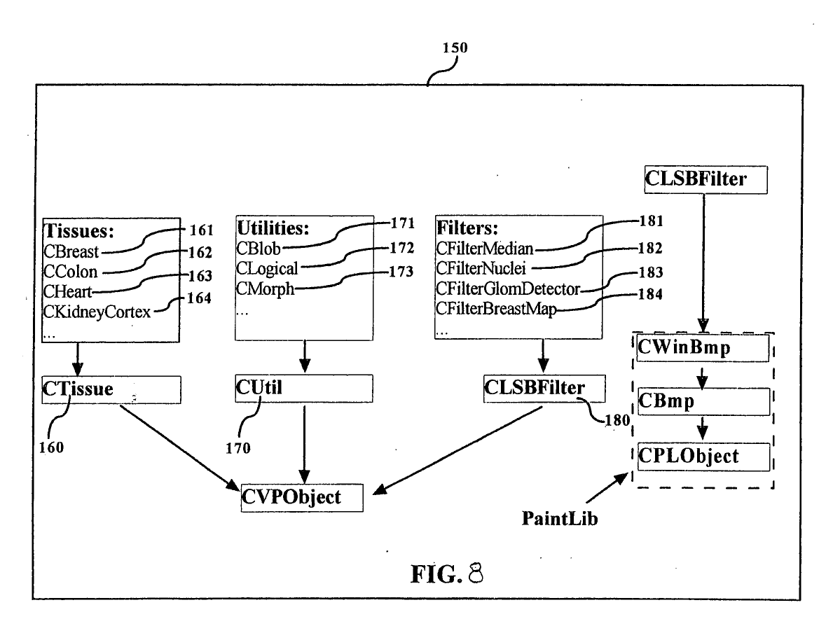

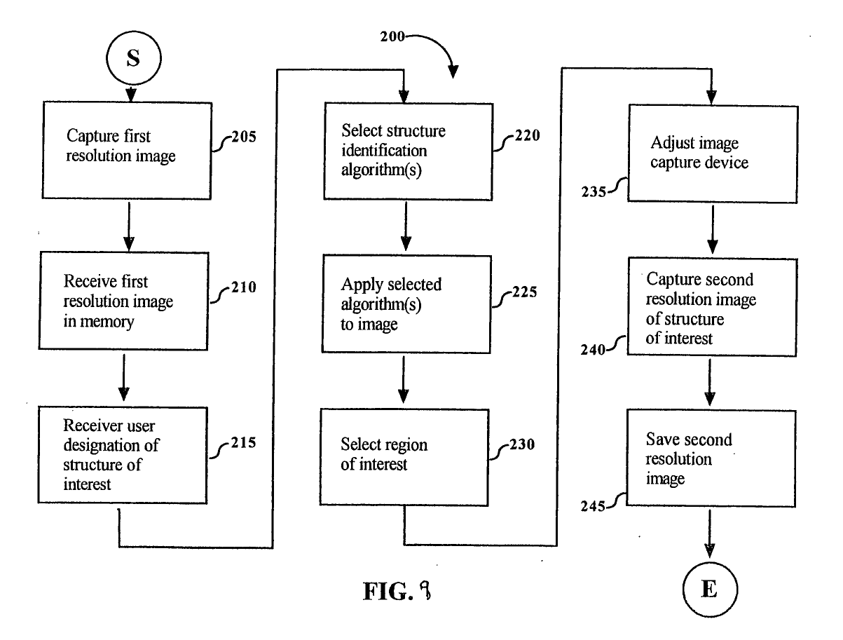

A median filter is then applied to the residual image to remove significant data acquisition noise and examined to determine its statistical properties. It is then converted to a point-to-point variance mapping by computing the local neighborhood signal variance in the pixel intensity at each point on a 3×3 box kernel interval. The results of this operation are then phase shifted by 25 percent of the signal dynamic range and non-linearly stretched by the response function shown in FIG. 4. This operation effectively flattens the image background and removes the majority of stitching panel effects that might be present.

The resultant image is then scanned to determine the minimum, maximum, mean, and standard deviation of the stretched-variance signal content. A threshold level is then set at the mean value, plus three-quarters of a standard deviation. All signal below that level is set to zero and all signal equal to or above is set to 255, creating a binary tissue mask representing regions of interest where tissue may be imaged. A variety of known morphological region filling and smoothing operators are then applied to close the resulting tissue mask regions of interest.

Coverslip line artifacts often appear within the FOV image. The procedure to eliminate this artifact begins with iteratively scanning the image tissue mask boundaries and testing each group of clustered pixels to determine if they are linear in form and intersect the boundary. Any found to be at least 33% of the FOV in width or 50% of the FOV height and are of truly narrow and linear form are then removed from the tissue mask.

Finally, each individual connected grouping of pixels within the tissue mask is then detected and assigned a unique tag. The grouping is then subjected to an edge tracing utility and the outside boundary of pixels is tagged as the negative value of that tag. During this operation, the tissue cluster's centroid coordinates, bounding limits, eccentricity and roundness measures are computed and stored in an unordered list for later use in associating the objects with a location assignment. The objects are left as unordered because of the frequent irregular placement of tissues on the slide. As a consequence of the manufacturing process, multiple tissue arrays may be placed on slides slightly askew. They may be warped and rotated with respect to X-Y axes define by, for example, the slide edges. As discussed in greater detail below, the effects of tissue warpage and rotation are accounted for during the targeting procedure.

Using location attributes for each object and the intensity FOV image, an analysis of object size, texture and density is performed. Objects that fail to meet predefined size, texture and density thresholds are removed from the binary image. This is done to eliminate extraneous objects such as slide labels and artifacts, which may inadvertently appear in the tissue field of view. The processed binary image is saved for use in the targeting procedure.

As discussed in greater detail below, the targeting procedure involves the creation of a theoretical slide array grid. The theoretical array is then superimposed over the binary tissue image using a best-fit optimization procedure, in order to accommodate warpage and rotational variations resulting from tissue placement on the slide. Once the grid has been optimally placed, tissue objects found in the segmentation step are assigned to row-column positions. The association of the tissue object with a position in the array allows for the identification of the tissue type by query to a slide database.

The first step in the targeting process is to determine the rotational angle of the tissue array 24. This angle may occur as a consequence of the slide manufacturing process. Referring to FIG. 5, histogram analyses along the X and Y axes of the binary image 400 of the array 24 are conducted to measure the maximum (tissue objects; white) and the minimum (background; black) intensities. For each row and column in the array 24, there is a corresponding intensity curve 410, 420 on each axis. For example, if there are 4 rows and 6 columns in the array, there will be 4 corresponding curves on the Y-axis, and 6 corresponding curves on the X-axis. The areas under each curve 410, 420 are determined and added for each axis. Peak minima and maxima are recorded.

The image is then rotated in 0.5° increments by re-mapping pixels about the center of the image. The process of histogram analysis and accumulation of curve area data is repeated through a range of degrees. The angle of rotation that corresponds to the largest cumulative separation of tissue and void space under the X and Y-axes is recorded as the rotational angle for the array 24.

The mean size of the tissue objects in the binary image, and the mean X and Y distances between the objects are determined. The data is then used, along with prior knowledge, acquired, for example, by a reading of the bar code 25 associated with the FOV image, of the number of rows and columns in the array 24 to generate a theoretical array 510, as illustrated in FIG. 5. Each element 520 in the array 510 is a radial sampler, with a diameter that corresponds to the mean values determined by scan analysis. The distances 530 between the elements 520 also reflects the measured means. Each array element 520 corresponds to a known row/column position (i.e., A1, D3), which is referenced in the above-referenced tissue identity database description of the slide 28 that may be stored, for example, in the memory 120. The theoretical array 510 is recorded in the form of a binary image.

As further illustrated in FIG. 6, the theoretical image 510 is overlayed on top of the binary tissue image 400. A measure of coincidence between the theoretical spots 520 and the tissue spots 26 is made. The theoretical image 510 is then moved in a pixel-wise manner, along the X and Y axes with respect to the array 24. Measurements of coincidence between the theoretical spots 520 and tissue spots 26 are made with each iteration, and compared to the previous iteration. The theoretical image 510 is at the optimum position for overlay when the measure of coincidence reaches a maximum value. Measures of coincidence are made using the AND operator on the two binary images 400, 510, giving equal weight to tissue and void space.

The centroid for each theoretical spot 520 is then calculated. Distance vectors are drawn from the centroids of each theoretical spot 520 to a distance of 0.5 radius, around the centroid. The expanded area around the spot 520 and the tissue objects 26 in the binary image 400 are compared. Tissue objects 26 that are located within 0.5 radii are assigned to the row/column identifier for that theoretical spot 520. The process is repeated, using progressively wider radii, until all of the qualifying objects in the un-ordered list are assigned to a row/column identifier. Those objects that do not coincide within 1.5 radii are not assigned to an identifier, and are consequently regarded as outliers. The iterative nature of the fitting process allows the system to accommodate small and badly fragmented tissue objects 26, as well as tissue objects 26 that are out of alignment.

During the assignment process, tissue object listings in the unordered tissue object list are removed as objects 26 are assigned. All subsequent iterations of the comparison process in the previous step are checked against the list to be sure that only objects 26 in the list are assigned a location identifier. This ensures that each tissue object 26 is only assigned to one location. Without this qualification, it would be possible for large tissue fragments to be assigned to multiple array locations.

New boundaries for each tissue location are calculated as upper left, lower right and centroid pixel coordinates, creating a new tissue ID map. Pixels within each new boundary are marked so as to indicate occupancy by tissue or void space. This new map allows the microscope control software to acquire images of tissue in a more discrete manner; avoiding inter- and intra-tissue void space. This map may also be used at various scales to guide the collection of images.

Referring to FIG. 7, illustrated is a process 600 for mapping an array of tissues mounted on, for example, a slide, according to an embodiment of the invention. In a first step 610, a slide upon which are mounted a set of tissue samples to be mapped is staged on the microscope 21. In a step 620, the camera 23 captures an image of the tissue set and transmits the image to the computing device 100. In a step 630, the imaging system 110, in the manner described above, differentiates the tissue samples from artifacts that may be present on the image. In a step 640, the imaging system 110 operates to identify the position of each sample in the image. In a step 650, the tissue samples are manually identified and each tissue sample identification is stored with a corresponding array position in a database. In a step 660, the imaging system 110 operates to identify each tissue sample by comparing the respective positions of the tissue samples within the theoretical array described above with the stored array positions.

FIG. 1B illustrates an auxiliary digital image 30 of the tissue microarray 24 that includes an auxiliary level image of each tissue sample in the tissue microarray 24, including an auxiliary tissue sample image 36 of the tissue sample 26 and the barcode. The image 30 is mapped by the robotic microscope 21 to determine the location of the tissue sections within the microscope slide 28. The barcode image is analyzed by commercially available barcode software, and slide identification information is decoded.

System 20 automatically generates a sequence of stage positions that allows collection of a microscopic image of each tissue sample at a first resolution. If necessary, multiple overlapping images of a tissue sample can be collected and stitched together to form a single image covering the entire tissue sample. Each microscopic image of tissue sample is digitized into a first pixel data set representing an image of the tissue sample at a first resolution that can be processed in a computer system. The first pixel data sets for each image are then transferred to a dedicated computer system for analysis. By imaging only those regions of the microscope slide 28 that contain a tissue sample, the system substantially increases throughput. At some point, system 20 will acquire an identification of the tissue type of the tissue sample. The identification may be provided by data associated with the tissue microarray 24, determined by the system 20 using the mapping process described above, using a method that is beyond the scope of this discussion, or by other means.

FIG. 1C illustrates a tissue sample image 46 of the tissue sample 26 acquired by the robotic microscope 21 at a first resolution. For a computer system and method to recognize a tissue constituent based on repeating multi-cellular patterns, the image of the tissue sample should have sufficient magnification or resolution so that features spanning many cells as they occur in the tissue are detectable in the image. A typical robotic pathology microscope 21 produces color digital images at magnifications ranging from 5× to 60×. The images are captured by a digital charge-couple device (CCD) camera and may be stored as 24-bit tagged image file format (TIFF) files. The color and brightness of each pixel may be specified by three integer values in the range of 0 to 255 (8 bits), corresponding to the intensity of the red, green and blue channels respectively (RGB). The tissue sample image 46 may be captured at any magnification and pixel density suitable for use with system 20 and algorithms selected for identifying a structure of interest in the tissue sample 26. As used herein, the identification of the structure of interest may be accomplished by identifying the structure itself or the structure plus the region surrounding the structure within a certain predetermined tolerance. Magnification and pixel density may be considered related. For example, a relatively low magnification and a relatively high-pixel density can produce a similar ability to distinguish between closely spaced objects as a relatively high magnification and a relatively low-pixel density. An embodiment of the invention has been tested using 5× magnification and a pixel dimension of a single image of 1024 rows by 1280 columns. This provides a useful first pixel data set at a first resolution for identifying a structure of interest without placing excessive memory and storage demands on computing devices performing structure-identification algorithms. As discussed above, the tissue sample image 46 may be acquired from the tissue sample 26 by collecting multiple overlapping images (tiles) and stitching the tiles together to form the single tissue sample image 46 for processing.

Alternatively, the tissue sample image 46 may be acquired using any method or device. Any process that captures an image with high enough resolution can be used, including methods that utilize other frequencies of electromagnetic radiation other than visible light, or scanning techniques with a highly focused beam, such as an X-ray beam or electron microscopy. For example, in an alternative embodiment, an image of multiple cells within a tissue sample may be captured without removing the tissue from the organism. There are microscopes that can show the cellular structure of human skin without removing the skin tissue. The tissue sample image 46 may be acquired using a portable digital camera to take a digital photograph of a person's skin. Continuing advances in endoscopic techniques may allow endoscopic acquisition of tissue sample images showing the cellular structure of the wall of the gastrointestinal tract, lungs, blood vessels and other internal areas accessible to such endoscopes. Similarly, invasive probes can be inserted into human tissues and used for in vivo tissue sample imaging. The same methods for image analysis can be applied to images collected using these methods. Other in vivo image generation methods can also be used provided they can distinguish features in a multi-cellular image or distinguish a pattern on the surface of a nucleus with adequate resolution. These include image generation methods such as CT scan, MRI, ultrasound, or PET scan.

FIG. 1D illustrates the system 20 providing the tissue image 46 to a computing device 100 in a form of a first pixel data set at a first resolution. The computing device 100 receives the first pixel data set into a memory over a communications link 118. The system 20 may also provide an identification of the tissue type from the database associated with the tissue image 46 using the barcode label.

An application running on the computing device 100 includes a plurality of structure-identification algorithms. At least two of the structure-identification algorithms of the plurality of algorithms are responsive to different tissue types, and each structure-identification algorithm correlating at least one cellular pattern in a given tissue type with a presence of a structure of interest for the given tissue type. The application selects at least one structure-identification algorithm responsive to the tissue type, and applies the selected algorithm to determine a presence of a structure of interest for the tissue type.

The application running on the computing device 100 and the system communicate over the communications link 118 and cooperatively adjust the robotic microscope 21 to capture a second pixel data set at a second resolution. The second pixel data set represents an image 50 of the structure of interest. The second resolution provides an increased degree to which closely spaced objects in the image can be distinguished from one another over the first resolution. The adjustment may include moving the high-resolution translation stage of the robotic microscope 21 into a position for image capture of the structure of interest. The adjustment may also include selecting a lens 22 having an appropriate magnification, selecting a CCD camera having an appropriate pixel density, or both, for acquiring the second pixel data set at the higher, second resolution.

The application running on the computing device 100 and the system 20 cooperatively capture the second data set. If multiple structures of interest are present in the tissue sample 26, multiple second pixel data sets may be captured from the tissue image 46. The second pixel data set is provided by system 20 to computing device 100 over the communications link 118. The second pixel data set may have a structure-identification algorithm applied to it for location of a structure of interest, or be stored in the computing device 100 along with the tissue type and any information produced by the structure-identification algorithm. Alternatively, the second pixel data set representing the structure of interest 50 may be captured on a tangible visual medium, such as photosensitive film in a camera or a computer monitor, or printed from the computing device 100 in any type of visual display, such as a monitor or an ink printer, or provided in any other suitable manner. The first pixel data set may then be discarded. The captured image can be further used in a fully automated process of localizing gene expression within normal and diseased tissue, and identifying diseases in various stages of progression. Such further uses of the captured image are beyond the scope of this discussion.

Capturing a high-resolution image of a structure of interest 50 (second pixel data set) and discarding the low-resolution image (first pixel data set) minimizes the amount of storage required for automated processing. Those portions of the tissue sample 26 having a structure of interest are stored. There is no need to save the low-resolution image (first pixel data set) because relevant structures of interest have been captured in the high-resolution image (second pixel data set).

FIG. 8 is a class diagram illustrating several object class families 150 in an image capture application that automatically captures an image of a structure of interest in a tissue sample, according to an embodiment of the invention. The object class families 150 include a tissue class 160, a utility class 170, and a filter class 180. The filter class 180 is also referred to herein as “a plurality of structure-identification algorithms.” While aspects of the application and the method of performing automatic capture of an image of a structure of interest may be discussed in object-orientated terms, the aspects may also be implemented in any manner capable of running on a computing device, such as the computing device 100 of FIG. 1D. In addition to the object class families 150, FIG. 8 also illustrates object classes CVPObject and CLSBImage that are part of an implementation that was built and tested. Alternatively, the structure identification algorithms may be automatically developed by a computer system using artificial intelligence methods, such as neural networks, as disclosed in U.S. application Ser. No. 10/120,206 entitled “Computer Methods for Image Pattern Recognition in Organic Material,” filed Apr. 9, 2002.

FIG. 8 illustrates an embodiment of the invention that was built and tested for the tissue types, or tissue subclasses, listed in Table 1. The tissue class 160 includes a plurality of tissue type subclasses, one subclass for each tissue type to be processed by the image capture application. A portion of the tissue type subclasses illustrated in FIG. 8 are breast 161, colon 162, heart 163, and kidney cortex 164.

TABLE 1
Tissue types

| | | Responsive Filter Class |
|---|---|---|
| | | (180) |
| Tissue Type | Tissue | (responsive structure- |
| (160) | Constituents | identification algorithms) |
| Bladder | Surface Epithelium, | FilterBladderZone |
| | Smooth Muscle, | |
| | Lamina Propria | |
| Breast | Ducts/Lobules, Stroma | FilterBreastMap. |
| | | FilterBreastDucts |
| Colon | Epithelium, Muscularis | FilterColonZone, |
| | Mucosa, Smooth Muscle, | |
| | Submucosa | |
| Heart | Tissue (generic) | FilterSkeletalMuscle |
| Kidney Cortex | Glomerali, PCTS, DCTs, | FilterKidneyCortexMap, |
| | | FilterGlomDetector, |
| | | FilterTubeDetector |
| Kidney Medulla | Ducts | FilterKidneyDetector, |
| | | FilterDuctDetector |
| Liver | Portal Triad | FilterLiverMap |
| Lung | Alveoli, Respiratory | FilterLungMap |
| | Epithelium | |
| Lymph Node | Mantle Zone of Lymphoid | FilterLymphnodeMap |
| | Follicle | |
| Nasal Mucosa | Epithelium | FilterNasalMucosaZone |
| Placenta | Tissue (generic) | FilterPlacenta |
| Prostate | Glands, Stroma, | FilterProstateMap |
| | Epithelium | |
| Skeletal Muscle | Tissue (generic) | FilterSkeletalMuscle |
| Skin | Epidermis | FilterSkinMap |
| Small Intestine | Epithelium, Muscularis | FilterSmIntZone |
| | Mucosa, Smooth Muscle, | |
| | Submucosa | |
| Spleen | White Pulp | FilterSpleenMap |
| Stomach | Epithelium, Muscularis | FilterStomachZone |
| | Mucosa, Smooth Muscle, | |
| | Submucosa | |
| Testis | Leydig Cells | FilterTestisMap |
| Thymus | Lymphocytes, Hassall's | FilterThymusMap |
| | Corpuscles | |
| Thyroid | Follicles | FilterThyroidMap, |
| | | FilterThyroidZone |
| Tonsil | Mantle Zone of Lymphoid | FilterTonsilMap |
| | Follicle, Epithelium | |
| Uterus | Glands, Stroma, Smooth | FilterUterusZone |
| | Muscle | |

For the tissue types of Table 1, the structure of interest for each tissue type consists of at least one of the tissue constituents listed in the middle column, and may include some or all of the tissue components. An aspect of the invention allows a user to designate which tissue constituents constitute a structure of interest. In addition, for each tissue type of Table 1, the right-hand column lists one or more members (structure-identification algorithms) of the filter class 180 (the plurality of structure-identification algorithms) that are responsive to the given tissue type. For example, a structure of interest for the colon 162 tissue type includes at least one of Epithelium, Muscularis Mucosa, Smooth Muscle, and Submucosa tissue constituents, and the responsive filter class is FilterColonZone. As illustrated by Table 1, the application will call FilterColonZone to correlate at least one cellular pattern formed by the Epithelium, Muscularis Mucosa, Smooth Muscle, and Submucosa tissue constituents to determine a presence of a structure of interest in the colon tissue 162.

A portion of the filter subclasses of the filter class 180 is illustrated in FIG. 8 as FilterMedian 181, FilterNuclei 182, FilterGlomDetector 183, and FilterBreastMap 184. Table 2 provides a more complete discussion of the filter subclasses of the filter class 180 and discusses several characteristics of each filter subclass. The filter class 180 includes both specific tissue-type-filters and general-purpose filters. The “filter intermediate mask format” column describes an intermediate mask prior to operator(s) being applied to generate a binary structure mask.

TABLE 2
Filter Subclasses

| | | | Filter |
|---|---|---|---|
| | | | Intermediate |
| Subclasses | Short Description | Input Format | Mask Format |
| Tissue-Specific Filters | | | |
| FilterAdrenalMap | Map regions of the Adrenal | 32 bpp tissue | 32 bpp color map |
| | | image at ≧5× | BLUE: gland tissue |
| | | | GREEN: capsule |
| FilterBladderZone | Map regions of the Bladder | 32 bpp tissue | 32 bpp (R = G = B) |
| | | image at 5× | Coded by gray level |
| FilterBreastDucts | Detect duct | 32 bpp tissue | 8 bpp mask |
| | structures in Breast | image at ≧5× | |
| FilterBreastMap | Map the structures | 32 bpp tissue | 32 bpp color map |
| | of the Breast | image at ≧5× | BLUE: ducts/lobules |
| | | | GREEN: stroma |
| FilterCerebellum | Map the layers of | 32 bpp tissue | 32 bpp color map |
| | the Brain Cerebellum | image at ≧5× | BLUE: lumen |
| | | | GREEN: molecular layer |
| | | | RED: granular layer |
| FilterColonZone | Map the regions of | 32 bpp tissue | 32 bpp (R = G = B) |
| | the Colon | image at 5× | Coded by gray level |
| FilterDuctDetector | Detect duct structures | 32 bpp tissue | 32 bpp color map |
| | in Kidney Medulla | image at ≧5× | BLUE: empty |
| | | | GREEN: duct + Henle lumen |
| | | | RED: duct lumen |
| FilterGlomDetector | Detects the | 32 bpp tissue | 32 bpp color map |
| | glomeruli and the | image at ≧5× | BLUE: gloms |
| | Bowman's capsule | | GREEN: bowman |
| | in Kidney Cortex. | | RED: lumen |
| FilterKidneyCortexMap | Map the structures | 32 bpp tissue | 32 bpp color map |
| | of the Kidney Cortex | image at ≧5× | BLUE: gloms |
| | | | MAGENTA: Bowman's capsule |
| | | | GREEN: DCT |
| | | | RED: PCT |
| FilterKidneyMedullaMap | Map the structures | 32 bpp tissue | 32 bpp color map |
| | of the Kidney Medulla | image at ≧5× | GREEN: duct + Henle lumen |
| | | | RED: duct lumen |
| FilterLiverMap | Map the locations | 32 bpp tissue | 32 bpp color map |
| | of the portal triads | image at ≧5× | BLUE: portal triad |
| | in Liver | | GREEN: portal triad |
| | | | RED: portal triad |
| FilterLungMap | Map the alveoli and | 32 bpp tissue | 32 bpp color map |
| | respiratory | image at ≧5× | BLUE: alveoli |
| | epithelium in Lung | | GREEN: epithelium |
| FilterLymphnodeMap | Map the structures | 32 bpp tissue | 32 bpp color map |
| | of the Lymph Node | image at ≧5× | BLUE: mantle zone of |
| | | | lymphoid follicle |
| FilterNasalMucosaZone | Map the regions of | 32 bpp tissue | 32 bpp (R = G = B) |
| | the nasal mucosa | image at 5× | Coded by gray level |
| FilterPlacenta | Map tissue in Placenta | 32 bpp tissue image | 8 bpp mask |
| FilterProstateMap | Detects the glands, | 32 bpp tissue | 32 bpp color map |
| | stroma and epithelium | image at ≧5× | BLUE: glands |
| | in Prostate | | GREEN: stroma |
| | | | RED: epithelium |
| FilterSkeletalMuscle | Maps the tissue | 32 bpp tissue | 8 bpp mask |
| | areas in skeletal muscle | image at ≧5× | |
| FilterSkinMap | Map the structures | 32 bpp tissue | 32 bpp color map |
| | of the Skin | image at ≧5× | BLUE: epidermis |
| | | | GREEN: epidermis |
| | | | RED: epidermis |
| FilterSmIntZone | Map the regions of | 32 bpp tissue | 32 bpp (R = G = B) |
| | the Small Intestine | image at 5× | Coded by gray level |
| FilterSpleenMap | Map the structures | 32 bpp tissue | 32 bpp color map |
| | of the Spleen | image at ≧5× | BLUE: white pulp |
| FilterStomachZone | Map the regions of | 32 bpp tissue | 32 bpp (R = G = B) |
| | the Stomach | image at 5× | Coded by gray level |
| FilterTestisMap | Map the structures | 32 bpp tissue | 32 bpp color map |
| | of the Testis system | image at ≧5× | BLUE: interstitial region |
| | | | GREEN: Leydig cells |
| | | | RED: seminiferous tubules |
| FilterThymusMap | Map the lymphocyte | 32 bpp tissue | 32 bpp color map |
| | areas and Hassall's | image at ≧5× | BLUE: lymphocytes |
| | corpuscles in Thymus | | GREEN: Hassall's |
| FilterThyroidMap | Map the Follicles in | 32 bpp tissue | 8 bpp mask |
| | Thyroid | image at ≧5× | |
| FilterThyroidZone | Map the Follicles in | 32 bpp tissue | 32 bpp (R = G = B) |
| | Thyroid | image at 5× | Coded by gray level |
| FilterTonsilMap | Map the structures | 32 bpp tissue | 32 bpp color map |
| | of the Tonsil | image at ≧5× | BLUE: mantle zone of |
| | | | lymphoid follicle |
| FilterTubeDetector | Detects the tubule | 32 bpp tissue | 32 bpp color map |
| | structures in the | image at ≧5× | BLUE: empty |
| | Kidney Cortex and | | GREEN: PCT + DCT lumen |
| | classifies them as | | RED: DCT lumen |
| | PCT or DCT | | |
| FilterUterusZone | Map the regions of | 32 bpp tissue | 32 bpp (R = G = B) |
| | the Uterus | image at 5× | Coded by gray level |
| General-Purpose Filters | | | |
| FilterDistanceMap | Distance transform | 8 or 32 bpp | 8 or 32 bpp gray |
| | | binary image | level distance map |
| FilterDownSample | Down-samples an | 8 or 32 bpp image | 8 or 32 bpp |
| | image by binning | | down-sampled image |
| FilterDSIntensity | Computes intensity | 8 or 32 bpp image | 8 bpp image |
| | image by averaging | | (may be down-sampled) |
| | the R, G & B with | | |
| | optional simultaneous | | |
| | down sampling | | |
| FilterEnhance | Fast digital enhancement | 8 or 32 bpp image | 8 or 32 bpp |
| | (RGB to RGB) | | enhanced image |
| FilterEpithelium | Detects epithelial | 32 bpp tissue | 8 bpp epithelium mask |
| | cells in tissues. | image | |
| | Parameters are set | | |
| | through access functions. | | |
| FilterErodeNuclei | Thresholded erosion | 8 or 32 bpp | 8 or 32 bpp |
| | of components in | binary image | eroded binary image |
| | binary image | | |
| FilterExpandNuclei | Thresholded expansion | 8 or 32 bpp | 8 or 32 bpp |
| | of components binary | binary image | expansion binary image |
| | image | | |
| FilterFastAverage | Fast averaging filter | 8 or 32 bpp image | 8 or 32 bpp local |
| | with optional | | average image |
| | normalization | | |
| FilterFractalDensity | Computes the fractal | 8 or 32 bpp | 8 or 32 bpp |
| | density map of a | binary image | fractal density image |
| | black-and-white image | | |
| FilterIPLRotate | Rotates image | 32 bpp image | 32 bpp rotated image |
| FilterJoinComponents | Morphologically | 8 or 32 bpp | 8 or 32 bpp |
| | joins components that | binary image | binary image |
| | are close together | | |
| FilterMask | Extracts a 8 bpp image | 32 bpp image | 8 bpp image |
| | from a 32 bpp bitmap | | |
| FilterMedian | Computes median filter | 8 or 32 bpp image | 8 or 32 pp |
| | | | filtered image |
| FilterNuclei | Computes a nuclei mask | 32 bpp tissue | 8 bpp nuclei mask |
| | using a segmentation | image at ≧5× | |
| | technique. | | |
| FilterResizeMask | Resizes binary images | 8 or 32 bpp | 8 or 32 bpp |
| | | binary image | binary image |
| FilterROISelector | Finds candidate | 8 bpp binary | Places the ROI |
| | regions of interest | image | information in the |
| | based a supplied | | ROIlist data structure. |
| | structure mask. | | |
| FilterSegment | Computes a segmented | 32 bpp tissue | 32 bpp color map |
| | image where nuclei, | image | BLUE: dark pixels |
| | white space and Vector | | GREEN: white pixels |
| | red are identified. | | RED: Vector red |
| FilterSuppressVR | Suppresses or removed | 32 bpp tissue | 32 bpp tissue image |
| | Vector Red content from | image | |
| | the tissue image | | |
| FilterTextureMap | Computes the variance- | 8 or 32 bpp image | 8 bpp texture map |
| | based texture map | | |
| FilterTissueMask | Computes a mask | 32 bpp tissue | 8 bpp tissue mask |
| | that indicates the | image | |
| | location of the | | |
| | tissue in an image | | |
| | (i.e. not white space) | | |
| FilterWhiteSpace | Computes a white | 32 bpp tissue | 8 bpp white-space |
| | space mask using a | image | mask |
| | user-selectable method. | | |
| FilterZoom | Fast digital zoom | 8 or 32 bpp image | 8 or 32 bpp |
| | (RGB to RGB) | | digitally zoomed |
| | | | image |

For example, when determining the presence of a structure of interest for the colon 162 tissue type, the application will call the responsive filter class FilterColonZone. Table 2 establishes that the FilterColonZone will map the regions of the Colon with 32 bpp using a first pixel data set representing the tissue sample at a resolution image magnification of 5×, and will compute an intermediate mask at 32 bpp (R=G=B) coded by gray level. An aspect of the invention is that the subfilters of the filter class 180 utilizes features that are intrinsic to each tissue type, and do not require the use of special stains or specific antibody markers.

A more detailed discussion of the filters in Table 2 may be found in commonly owned PCT Patent Application No. PCT/U.S. 2003/019206 titled COMPUTERIZED IMAGE CAPTURE OF STRUCTURES OF INTEREST WITHIN A TISSUE SAMPLE, filed 17 Jun. 2003, which is hereby incorporated herein by reference in its entirety for all purposes.

FIG. 9 is a diagram illustrating a logical flow 200 of a computerized method of automatically capturing an image of a structure of interest in a tissue sample, according to an embodiment of the invention. The tissue samples typically have been stained before starting the logical flow 200. The tissue samples are stained with a nuclear contrast stain for visualizing cell nuclei, such as Hematoxylin, a purple-blue basic dye with a strong affinity for DNA/RNA-containing structures. The tissue samples may have also been stained with a red alkaline phosphatase substrate, commonly known as “fast red” stain, such as Vector® red (VR) from Vector Laboratories. Fast red stains precipitate near known antibodies to visualize where the protein of interest is expressed. Such areas in the tissue are sometimes called “Vector red positive” or “fast red positive” areas. The fast red signal intensity at a location is indicative of the amount of probe binding at that location. The tissue samples often have been stained with fast red for uses of the tissue sample other than determining a presence of a structure of interest, and the fast red signature is usually suppressed by structure-identification algorithms of the invention. Tissue samples may alternatively be stained with a tissue contrasting stain, such as Eosin; and may make use of alternate stains to fast red such as Diaminobenzidine (DAB) or tetrazolium salts such as BCIP/NBT.

After a start block S, the logical flow moves to block 205, where a microscopic image of the tissue sample 26 at a first resolution is captured. Also at block 205, a first pixel data set representing the captured-color image of the tissue sample at the first resolution is generated. Further, the block 205 may include adjusting an image-capture device to capture the first pixel data set at the first resolution.

The logic flow moves to block 210, where the first pixel data set and an identification of a tissue type of the tissue sample are received into a memory of a computing device, such as the memory 104 of the computing device 100. The logical flow then moves to block 215 where a user designation of a structure of interest is received. For example, a user may be interested in epithelium tissue constituents of colon tissue. At block 215, the logic flow would receive the user's designation that epithelium is the structure of interest.

Next, the logic flow moves to block 220, where at least one structure-identification algorithm responsive to the tissue type is selected from a plurality of stored structure-identification algorithms in the computing device. At least two of the structure-identification algorithms of the plurality of algorithms are responsive to different tissue types, and each structure-identification algorithm correlating at least one cellular pattern in a given tissue type with a presence of a structure of interest for the given tissue type. The structure-identification algorithms may be any type of algorithm that can be run on a computer system for filtering data, such as the filter class 180 of FIG. 8.

The logical flow moves next to block 225, where the selected at least one structure-identification algorithm is applied to the first pixel data set representing the image. Using the previous example where the tissue type is colon tissue, the applied structure-identification algorithm is FilterColonZone. The FilterColonZone algorithm segments the first pixel data set into three classes of regions: nuclei, cytoplasm, and white space. Based on the segmentation result, a “density map” for each class is calculated. Using the density maps, the algorithm finds the potential locations of the “target zones” or cellular constituents of interest: epithelium, smooth muscle, submucosa, and muscularis mucosa Table 1. Each potential target zone is then analyzed with tools for local statistics, and morphological operations performed in order to get a more precise estimation of its location and boundary. Regions in an intermediate mask are labeled with the following gray levels for the four cellular constituents: epithelium—50, smooth muscle—100, submucosa—150, and muscularis Mucosa—200. A more detailed discussion of the algorithms used to segment the four cellular constituents may be found in the previously referenced PCT Patent Application No. PCT/U.S. 2003/019206.

A binary structure mask is computed from the filter intermediate mask generated by the structure-identification algorithm(s) applied to the first pixel data set. The binary structure mask is a binary image where a pixel value is greater than zero if a pixel lies within the structure of interest, and zero otherwise. If the filter intermediate mask includes a map of the user-designated structure of interest, the binary structure mask may be directly generated from the filter intermediate mask. If the filter intermediate mask includes cellular components requiring correlating to determine the presence of the structure of interest, the cellular components, a co-location operator is applied to the intermediate mask to determine whether there is a coincidence, an intersection, a proximity, or the like, between the cellular components of the intermediate mask. By way of further example, if the designated structure of interest for a colon tissue sample had included all four tissue constituents listed in Table 1, the binary structure mask will describe and determine a presence of a structure of interest by the intersection or coincidence of the locations of the cellular patterns of at least one of the four constituents constituting the structure of interest.

The binary structure mask typically will contain a “1” for those pixels in the first data sets where the cellular patterns coincide or intersect and a “0” for the other pixels. When a minimum number of pixels in the binary structure mask contain a “1,” a structure of interest is determined to exist. If there are no areas of intersection or coincidence, no structure of interest is present and the logical flow moves to an end block E. Otherwise, the logical flow moves to block 230 where at least one region of interest (ROI) having a structure of interest is selected for capture of the second resolution image.

A filter, such as the FilterROISelector discussed in Table 2, uses the binary structure mask generated at block 225 marking locations of the cellular constituents comprising the structure of interest to determine a region of interest. A region of interest is a location in the tissue sample for capturing a second resolution image of the structure of interest. A method of generating a region of interest mask includes dividing the binary structure mask image into a number of approximately equal size sections greater in number than a predetermined number of regions of interest to define candidate regions of interest. Next, an optimal location for a center for each candidate region of interest is selected. Then, each candidate region of interest is scored by computing the fraction of pixels within the region of interest where the mask has a positive value, indicating to what extent the desired structure is present. Next, the candidate regions of interest are sorted by the score with an overlap constraint. Then, the top-scoring candidate regions of interest are selected as the regions of interest.

Selecting the region of interest at block 230 may also include selecting optimal locations within each region of interest for capture of the second pixel data set in response to a figure-of-merit process. discussed in previously referenced PCT Patent Application No. PCT/U.S. 2003/019206. A method of selecting optimal locations in response to a figure-of-merit includes dividing each region of interest into a plurality of subsections. Next, a “best” subsection is selected by computing a figure of merit for each subsection. The figure of merit is computed filtering the binary structure mask with an averaging window of size matching the region of interest for a resulting figure of merit image that has values ranging from 0 to 1, depending on the proportion of positive mask pixels within the averaging window; and obtaining a figure of merit for a given subsection by averaging the figure of merit image over all the pixels in the subsection, with a higher number being better than a lower number. Finally, repeating the dividing and selecting steps until the subsections are pixel-sized.

The logic flow then moves to block 235, where the image-capture device is adjusted to capture a second pixel data set at a second resolution. The image-capture device may be the robotic microscope 21 of FIG. 1. The adjusting step may include moving the tissue sample relative to the image-capture device and into an alignment for capturing the second pixel data set. The adjusting step may include changing a lens magnification of the image-capture device to provide the second resolution. The adjusting step may further include changing a pixel density of the image-capture device to provide the second resolution.

The logic flow moves to block 240, where the image-capture device captures the second pixel data set in color at the second resolution. If a plurality of regions of interest are selected, the logic flow repeats blocks 235 and 240 to adjust the image-capture device and capture a second pixel data set for each region of interest. The logic flow moves to block 245 where the second pixel data set may be saved in a storage device, such in a computer memory or hard drive. Alternatively, the second pixel data set may be saved on a tangible visual medium, such as by printing on paper or exposure to photograph film.

The logic flow 200 may be repeated until a second pixel data set is captured for each tissue sample on a microscope slide. After capture of the second pixel data set, the logic flow moves to the end block E.

An alternative embodiment, the logic flow 200 includes an iterative process to capture the second pixel data set for situations where a structure-identification algorithm responsive to the tissue type cannot determine the presence of a structure of interest at the first resolution, but can determine a presence of regions in which the structure of interest might be located. In this alternative embodiment, at blocks 220, 225, and 230, a selected algorithm is applied to the first pixel data set and a region of interest is selected in which the structure of interest might be located. The image-capture device is adjusted at block 235 to capture an intermediate pixel data set at a resolution higher than the first resolution. The process returns to block 210 where the intermediate pixel data set is received into memory, and a selected algorithm is applied to the intermediate pixel data set to determine the presence of the structure of interest at block 225. This iterative process may be repeated as necessary to capture the second resolution image of a structure of interest. The iterative process of this alternative embodiment may be used in detecting Leydig cells or Hassall's corpuscles, which are often not discernable at the 5× magnification typically used for capture of the first resolution image. The intermediate pixel data set may be captured as 20× magnification, and a further pixel data set may be captured at 40× magnification for determination whether a structure of interest is present.

In some situations, an existing tissue image database may require winnowing for structures of interest, and possible discard of all or portions of images that do not include the structures of interest. An embodiment of the invention similar to the logic flow 200 provides a computerized method of automatically winnowing a pixel data set representing an image of a tissue sample having a structure of interest. The logical flow for winnowing a pixel data set includes receiving into a computer memory a pixel data set and an identification of a tissue type of the tissue sample similar to block 205. The logical flow would then move to blocks 220 and 225 to determine a presence of the structure of interest in the tissue sample. Upon completion of block 225, the tissue image may be saved in block 245 in its entirety, or a location of the structure of interest within the tissue sample may be saved. The location may be a sub-set of the pixel data set representing the image that includes the structure of interest may be saved. The logic flow may include block 230 for selecting a region of interest, and sub-set of the pixel data set may be saved by saving a region of interest pixel data sub-set.

The various embodiments of the invention may be implemented as a sequence of computer-implemented steps or program modules running on a computing system and/or as interconnected-machine logic circuits or circuit modules within the computing system. The implementation is a matter of choice dependent on the performance requirements of the computing system implementing the invention. In light of this disclosure, it will be recognized that the functions and operation of the various embodiments disclosed may be implemented in software, in firmware, in special purpose digital logic, or any combination thereof without deviating from the spirit or scope of the present invention.

Although the present invention has been discussed in considerable detail with reference to certain preferred embodiments, other embodiments are possible. Therefore, the spirit or scope of the appended claims should not be limited to the discussion of the embodiments contained herein. It is intended that the invention resides in the claims hereinafter appended.

1. A method, comprising:
receiving an image of a tissue-sample set;
electronically identifying a position in the image of each tissue sample relative to at least one other tissue sample; and
electronically identifying each tissue sample based on the tissue sample position identification.

2. The method of claim 1, further comprising staging on a magnification device a slide upon which the sample set is mounted.

3. The method of claim 2 wherein the slide is automatically staged.

4. The method of claim 1 wherein the image includes at least one artifact; and
further comprising electronically differentiating each tissue sample from the at least one artifact.

5. The method of claim 1, wherein identifying each tissue sample comprises electronically comparing the tissue-sample set with an array grid.

6. The method of claim 5 wherein the set is arranged in an array.

7. The method of claim 6, further comprising, prior to electronically identifying each sample, storing the size of the set array in a memory.

8. The method of claim 7 wherein the array grid is generated based on the set array in the memory.

9. The method of claim 1 wherein identifying each tissue sample comprises receiving an identification of the set.

10. The method of claim 9 wherein receiving an identification comprises reading a barcode label on a slide on which the set is mounted.

11. An article of manufacture, comprising: a machine-readable medium, comprising executable instructions to:
receive an image of a tissue-sample set;
identify a position in the image of each tissue sample relative to at least one other tissue sample; and
identify each tissue sample based on the tissue sample position identification.

12. The article of claim 11, wherein the medium comprises a modulated carrier signal.

13. An electronic system, comprising:
an interface; and
a processor coupled to the interface and operable to receive an image of a tissue-sample set, identify a position in the image of each tissue sample relative to at least one other tissue sample, and identify each tissue sample based on the tissue sample position identification.

14. A method, comprising:
acquiring an image of a first tissue sample captured at a first resolution;
electronically identifying a predetermined portion of the image; and
capturing, at a second resolution, the image portion.

15. The method of claim 14, further comprising capturing the image at the first resolution.

16. The method of claim 15 wherein capturing the image comprises receiving a signal indicating the location of the sample.

17. The method of claim 16 wherein the signal indicates the position of the sample within a tissue-sample array carried by a medium.

18. The method of claim 17 further comprising electronically determining the location of the sample on a medium.

19. The method of claim 14 wherein acquiring the image comprises receiving a signal identifying a tissue type of the first tissue sample.

20. The method of claim 19, wherein identifying the portion comprises selecting, based on the identified tissue type, an identification algorithm.

21. The method of claim 14, further comprising receiving a selection of the predetermined portion.

22. The method of claim 21 wherein the portion is identified based on the portion selection.

23. The method of claim 14 wherein the image portion is captured in response to identifying the image portion.

24. The method of claim 14 wherein capturing the image portion comprises receiving a signal indicating the location of the image portion

25. The method of claim 14 wherein the predetermined portion is defined by a structure of the first tissue sample.

26. The method of claim 25 wherein the structure comprises an abnormal cell feature.

27. The method of claim 14 wherein the second resolution is higher than the first resolution.

28. An electronic system, comprising:
an interface; and
a processor coupled to the interface and operable to identify a predetermined portion of an image, captured at a first resolution, of a first tissue sample; and
capture, at a second resolution, the image portion.

29. An apparatus, comprising: a computer-readable medium, comprising executable instructions to:
identify a predetermined portion of an image, captured at a first resolution, of a first tissue sample; and
capture, at a second resolution, the image portion.

30. An automated microscope slide tissue mapping and image acquisition system, comprising:
(a) a robotic microscope having a plurality of magnification objectives and equipped with a motorized stage and a digital image acquisition means;
(b) a computing system operable to control the robotic microscope and including a storage operable to store a database that includes information related to a plurality of microscope slides each having a plurality of mounted tissue samples;
(c) computer-executable instructions operable to:
(i) position a first microscope slide of the plurality of microscope slides with respect to a first microscope objective of the robotic microscope to capture a surface image of the first microscope slide, each slide of the plurality of microscope slides having a surface that includes a machine readable slide identifier and the plurality of mounted tissue sections;
(ii) acquire the whole surface image of the surface of the first microscope slide;
(iii) map a location of a first mounted tissue section of the plurality mounted tissue sections on the first slide;
(iv) acquire and read the identifier on the first slide;
(v) responsive to the read identifier, obtain information from the database associated with the read identifier, including a number of rows and columns of tissue sections on the surface of the first slide;
(vi) define a boundary the first tissue section;
(vii) position a microscope second objective with respect to the first slide to capture a first resolution image of the first tissue section in response to the defined boundary of the first tissue section;
(viii) acquire the first resolution image;
(ix) position a microscope third objective with respect to the first slide to capture a second resolution image of the first tissue section in response to the defined boundary;
(x) acquire the second resolution image;
(xi) repeat steps (a)-(x) for a second tissue section of the first slide; and
(xii) repeat steps (a)-(xi) for a second slide in the plurality of microscope slide

31. A method of automated microscope slide tissue mapping and image acquisition, comprising:
(d) receiving a plurality of microscope slides, each slide having a surface that includes a machine readable slide identifier and a plurality of mounted tissue sections;
(e) positioning the first microscope slide of the plurality of slides with respect to a microscope first objective to capture a whole surface image of the first slide;
(f) obtaining an image of the whole surface of the first microscope slide of the plurality of slides;
(g) mapping a location of a first mounted tissue section of the plurality mounted tissue sections on the first slide;
(h) acquiring and reading the identifier on the first slide;
(i) responsive to the read identifier, obtaining information from a database associated with the read identifier, including a number of rows and columns of tissue sections on the surface of the first slide;
(j) defining a boundary of the first tissue section;
(k) positioning the first tissue section with respect to a microscope second objective to acquire a first resolution image of the first tissue section in response to the determined boundary of the first tissue section;
(l) acquiring the first resolution image;
(m) positioning the first tissue section with respect to a microscope third objective to capture a second resolution image of the first tissue section in response to the determined boundary of the first tissue section;
(n) acquiring the second resolution image;
(o) repeating steps (a)-(k) for a second tissue section of the first slide; and
(p) repeating steps (a)-(l) for a second slide in the plurality of microscope slides.
